(19) United States
(12) Patent Application Publication
(10) Pub. No.: US 2011/0223292 A1
(43) Pub. Date: Sep. 15, 2011

(54) FROZEN CONFECTION HOLDER

(76) Inventors: Julie Kushner, Carmel, IN (US); Dara Wade, Carmel, IN (US)

(21) Appl. No.: 12/722,727

(22) Filed: Mar. 12, 2010

(51) Int. Cl. A23G 9/50; B65D 1/34

(52) U.S. Cl. 426/134; 220/571

(57) ABSTRACT

The present invention relates generally to a system and apparatus for holding frozen confections, and for catching and storing the drips or melting confection that results therefrom. The present invention includes a handle and a bowl or funnel-shaped drip catching member, the drip catching member including at least one drip slit or opening for allowing drips to migrate from the drip catching member down into an internal reservoir located within the handle. The internal reservoir stores the drips until emptied. The drip slits or openings are positioned within a drip-pass-through region of the drip catching member for allowing the drips to more efficiently migrate into the reservoir regardless of the angle at which the frozen confection holder is held.

### BACKGROUND OF INVENTION

The present invention relates generally to a system and apparatus for holding frozen confections, and catching and storing the drips or melting-confection that results therefrom. More particularly, the present invention relates to a system and apparatus having a handle and a bowl or funnel-shaped drip catching member wherein the drip catching member includes drip slits or openings for allowing the drips to migrate from the drip catching member down into an internal reservoir located in the handle. The internal reservoir stores the drips until emptied.

Many frozen confection holders exist today which include handles and drip catching members. For example, the simple drip catching structure shown in U.S. Patent Publication No. 2003/0087011 to Perkins utilizes a bowl or funnel shaped projection to catch drips from the frozen confection. Similarly, the funnel shaped drip catching structure shown in U.S. Pat. No. 4,239,175 to Straubinger causes the drips to migrate toward the bottom of the funnel shape member. However, such apparatus do not trap and hold the drips, instead they merely cause the drips to collect in a single place.

Somewhat more complex frozen confection holders function to trap drips in a reservoir inside the handle after such drips have been caught by the drip catching structure. For example, U.S. Pat. No. 6,571,979 to Schmarr discloses a drip catching member with drip holes immediately surrounding the frozen confection stick which allow drips to migrate into the handle reservoir. The drip catching member of U.S. Pat. No. 5,515,998 to Wang functions similarly. These frozen confection holders serve to catch and store drips in the internal reservoir of the handle until emptied.

However, frozen confection holders such as those disclosed in Wang and Schmarr utilize drip holes immediately adjacent the stick of the frozen confection. As such, in order for drips to quickly migrate down into the handle reservoir, the frozen confection must drip down the stick to the drip holes. For such a situation to occur, these devices must be held in a steady, vertical position to allow gravity to pull such drips directly downward. Where these devices are held in non-vertical positions, as is likely to be the case during much of the normal use of such devices, drips are likely to fall from the frozen confection away from the stick and drip holes. Depending on the orientation of the frozen confection holder, the above discussed funnel-shape of the drip catching structures may or may not cause the drips to migrate toward the drip holes. In any case, drips which fall into the drip catching structure away from the centralized drip holes are likely to linger in the drip catching structure longer than those drips which fall nearer to such drip holes.

Other frozen confection holders do utilize drip holes which are immediately adjacent the outer edge of the drip catching structure, such as the device disclosed in U.S. Pat. No. 5,224,646 to Biancosino. The drip holes of these frozen confection holders are positioned such that very few drips caught by a funnel-shaped drip catching structure would migrate toward such drip holes. Further, when such a frozen confection holder is turned on its side, even the smallest of drips that have collected within the handle reservoir would be able to leak out of drip holes placed at the outer edge of the drip catching structure. In fact, this is the stated purpose of the Biancosino device—to allow users to drink the collected drips through the drip holes.

Thus, there is a need for an improved frozen confection holder which catches and stores frozen confection drips and continues to function when the holder device is not held steady and vertically. Also, it is preferable that such frozen confection holders should hold and contain melted frozen confection even when the holder is turned on its side.

### SUMMARY OF THE INVENTION

The present invention provides a holder for frozen confections comprising a handle, a drip catching member, a frozen confection receiving member and at least one drip slit or opening. The handle includes a top end, a bottom end and an internal hollow portion which acts as a reservoir for retaining drips from the frozen confection. The drip catching member extends radially outward from the center of the top end of the handle to an outer edge in a generally circular or elliptical shape. The drip catching member curves upwardly away from the handle, thereby roughly forming a bowl shaped outer portion positioned to receive drips from the frozen confection.

The frozen confection receiving member is positioned generally toward the center of the drip catching member and includes an aperture extending through the drip catching member and top end of the handle. The aperture is sized, shaped and positioned to receive a stick or other portion of a frozen confection therethrough, causing the stick or other portion of the frozen confection to pass through the drip catching member and the handle top end, and into the handle reservoir. The at least one drip slit or opening is separate from and positioned outwardly from the frozen confection receiving member, and is separate from and positioned inwardly from the outer edge of the drip catching member. The at least one drip slit or opening extends through the drip catching member and handle top end into the handle reservoir for allowing frozen confection drips caught by the drip catching member to drip down into the handle reservoir for storage.

The handle may include a hole extending through its bottom end into the internal reservoir, and a plug for removable insertion into the hole. The plug thereby contains drips within the internal reservoir when engaged with the hole, and releases the drips when removed from the hole.

Additionally, the shape of the at least one drip slit or opening may mirror the transverse cross-sectional shape of an intended frozen confection. For example, where an intended frozen confection has a generally rectangular transverse cross section, the at least one drip slit may have a rectangular shape of approximately the same size as the transverse cross section of the intended frozen confection. The same applies to frozen confections having circular, square or otherwise shaped transverse cross sections. The drip slits may additionally or alternatively be elongated, running parallel to the semi-major axis of the circular or elliptical drip catching member, and may be crescent shaped to maintain roughly a uniform distance from the outer edge of the drip catching member.

The at least one drip slit or opening may also be positioned within a depression in the drip catching member such that the drip catching member slopes downwardly toward the at least one drip slit or opening from both sides, i.e., from the frozen confection receiving member and from the outer edge.

Further areas of applicability of the present invention will become apparent from the detailed description provided hereinafter. It should be understood that the detailed description and specific examples, while indicating several embodiments of the present invention, are intended for purposes of illustration only and are not intended to limit the scope of the invention.

### BRIEF DESCRIPTION OF THE DRAWINGS

The present invention will become more fully understood from the detailed description and the accompanying drawings.

FIG. 1 is a perspective view of an exemplary prior art frozen confection holding device with a drop hole adjacent the stick.

FIG. 2 is a perspective view of an exemplary prior art frozen confection holding device with a drop hole adjacent the stick tilted away from a vertical orientation.

FIG. 3 is a perspective view of the exemplary prior art frozen confection holding device of FIG. 2, shown tilted from a vertical position by 0 degrees.

FIG. 4 is a front perspective view of a frozen confection holder according to an embodiment of the present invention.

FIG. 5 is a side elevation cutaway view of a frozen confection holder showing the funnel-shape of the drip catching member.

FIG. 6 is a front elevation cutaway view of an alternative embodiment of a frozen confection holder taken along lines 6-6 of FIG. 4 showing drip holes positioned at the bottom of depressions in the drip catching member.

FIG. 7 is a top view of another embodiment of a frozen confection holder and drip pass-through region having elongated, crescent-shaped drip slits.

FIG. 8 is a top view of another embodiment of a frozen confection holder having drip slits forming a generally rectangular shape.

FIG. 9 is a top view of still another embodiment of a frozen confection holder having drip slits forming a generally square shape.

FIG. 10 is a top view of still another embodiment of a frozen confection holder having drip slits forming a generally circular shape.

FIG. 11 is a top view of a further embodiment of a frozen confection holder having a plurality of drip holes forming a generally crescent shape.

FIG. 12 is a side exploded view of a frozen confection holder and a frozen confection on a stick.

FIG. 13 is a side exploded view of a frozen confection holder and a frozen confection without a stick.

### DETAILED DESCRIPTION

The following description of the preferred embodiment(s) is merely exemplary in nature and is in no way intended to limit the various embodiments of the present invention, its applications, or uses.

Although the systems and devices for holding frozen confections described herein are preferably used in connection with frozen confections sold and consumed on a stick, such as ice pops, ice cream pops and the many products which include the suffix “-sicle,” their uses are not so limited. It is recognized and anticipated that the present systems and devices can be utilized in a wide variety of food consumption applications as will be hereinafter evident. With respect to the reference numbers used in the drawings, like numerals refer to like parts.

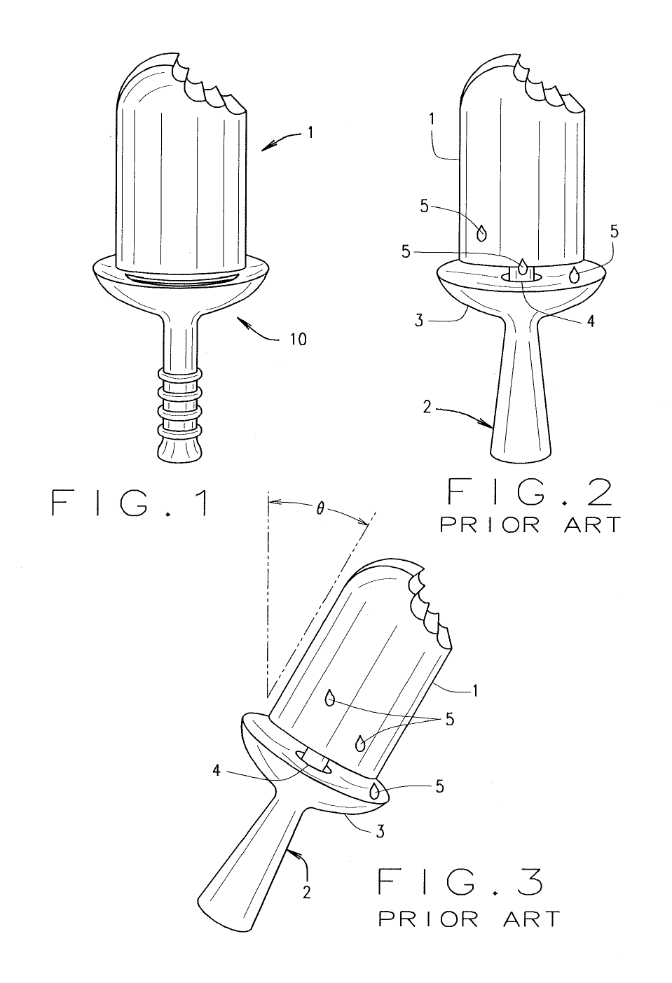

As seen in FIG. 1, an embodiment of the present invention provides for a frozen confection holder 10 for holding a frozen confection 1, and for catching and retaining the drips thereof. FIGS. 2 and 3 illustrate an exemplary prior art frozen confection holder 2. As can be seen, prior art frozen confection holders, such as that shown in FIG. 2 and as disclosed in U.S. Pat. No. 6,571,979 to Schmarr, catch drips 5 in a bowl-shaped drip catching member 3, and store such drips 5 in an internal reservoir in the holder handle. The prior art drip catching devices 2 utilize drip holes 4 immediately adjacent the stick of the frozen confection. As such, in order for the drips 5 to quickly migrate down into the handle reservoir, the frozen confection 1 must drip down the stick to the drip holes 4. For such a situation to occur, these devices 2 must be held in a steady, vertical position to allow gravity to pull such drips 5 directly downward.

Where such devices 2 are held in non-vertical positions, such as that shown in FIG. 3 and as is likely to be the case during much of the normal use of such devices 2, the confection drips 5 are likely to fall from the frozen confection away from the stick and away from the drip holes 4. Depending on the orientation of the frozen confection holder 2, the above discussed funnel-shaped drip catching structures 3 may or may not cause the drips to migrate toward the drip holes 4. As such, drips 5 which fall into the drip catching structure 3 away from the centralized drip holes 4 are likely to linger in the drip catching structure 3 longer than those drips 5 which fall nearer to such drip holes 4. The present invention attempts to resolve such problems.

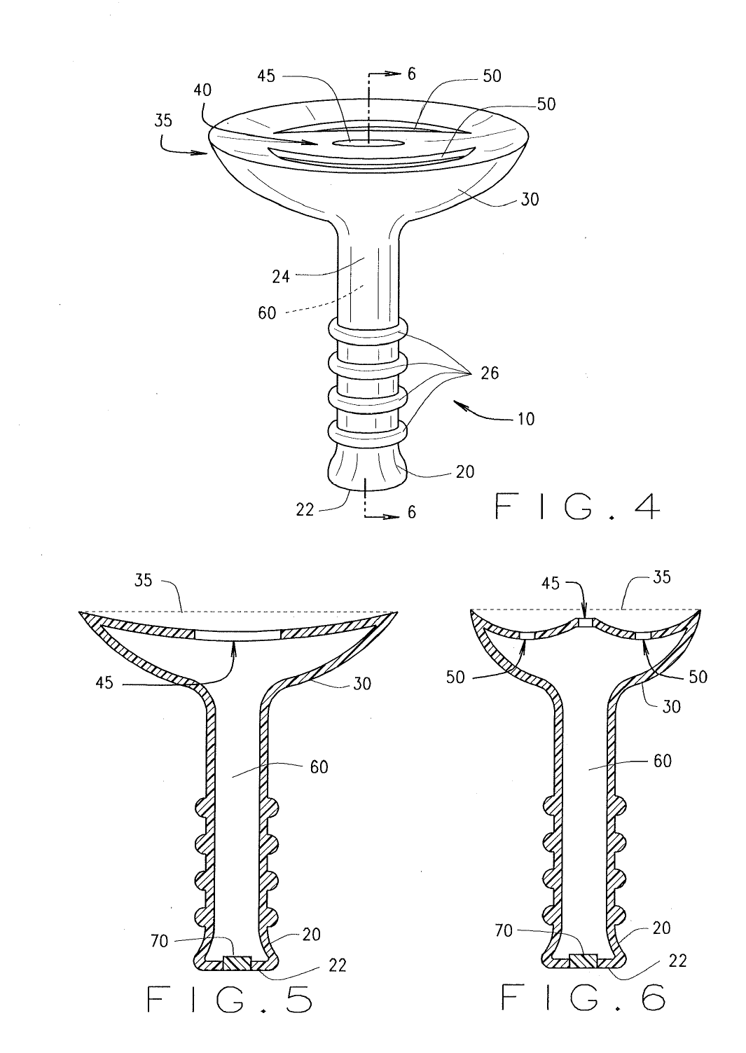

As can be seen in FIG. 4, the present frozen confection holder 10 includes a handle 20 which longitudinally extends from bottom end 22 to top end 24. Handle 20 also includes an internal hollow which serves as a drip holding reservoir 60, which is more clearly shown in FIGS. 5 and 6. Drip catching member 30 extends radially outward from the top end 24 of handle 20 to an outer edge 35 of the drip catching member 30. Drip catching member 30 forms a roughly bowl shape, and is positioned to receive drips from frozen confection 1.

Frozen confection receiving member 40 is positioned generally toward the center of the drip catching member 30, and includes an aperture 45 extending through the drip catching member 30 and the top end 24 of handle 20 into reservoir 60. Aperture 45 is positioned to receive the stick of a frozen confection 1, and to allow the stick to pass through drip catching member 30 and through the handle top end 24 into handle reservoir 60. As a result, frozen confection 1 is secured within the frozen confection holder 10, and a user can grasp handle 20 to hold the frozen confection 1. As in the prior art, drips 5 which fall from the frozen confection 1 are caught by the drip catching member 30.

In at least one embodiment of the present invention, at least one drip slit or opening 50 extends through the drip catching member 30 and through the handle top end 24 for communication with the handle reservoir 60. A drip slit or opening 50 allows frozen confection drips 5 caught by the drip catching member 30 to drip down into handle reservoir 60 for storage. Each drip slit 50 is preferably separate from and positioned outwardly from the frozen confection receiving member 40 and aperture 45. Additionally, each drip slit 50 is also preferably separate from and positioned inwardly from outer edge 35 of the drip catching member 30. The positioning of at least one drip slit 50 outwardly from aperture 45 allows for drips 5 which fall radially outward from aperture 45, such as those drops 5 shown in FIG. 3, to quickly migrate down into reservoir 60 without having to flow to aperture 45. As noted above, a tilted frozen confection holder 10 would result in drips that fall outwardly from both the stick of the frozen confection 1 and aperture 45. Gravity may or may not pull such drips 5 toward aperture 45, depending upon the orientation of the frozen confection holder 10 and the specific location of the drop 5. With drip slits or openings 50 spaced outwardly from aperture 45, drips 5 have a higher chance of migrating into the reservoir 60 even when the frozen confection holder 10 is tilted.

Additionally, by utilizing drip slits 50 which are separate from and positioned inwardly from outer edge 35 of the drip catching member 30, the reservoir 60 is better able to receive and retain drips 5 when caught therein. If the present frozen confection holder 10 is turned more than 90°, drips 5 held within reservoir 60 would flow from the bottom of reservoir 60 back up to the top toward the drip catching member 30. In prior art frozen confection holders with through-holes located at the outer edge 35, such drips 5 held within reservoir 60 would flow out those through-holes and spill when the confection holder is turned more than 90°. To the contrary, use of the present frozen confection holder 10 with drip slits or openings 50 positioned inward from the drip catching member outer edge 35, much or all of such spillage would be prevented.

FIG. 5 illustrates a side elevation cross-sectional view of the present frozen confection holder 10. As can be seen, drip catching member 30 is preferably generally bowl shaped, with aperture 45 positioned lower in the drip catching member 30 than outer edge 35. It is noted that aperture 45 may be the lowest point in the upper surface of the drip catching member 30 as shown in FIG. 5. Alternatively, and as is shown in FIG. 6, drip slits or openings 50 may be located in depressions within the upper surface of drip catching member 30 such that the drip catching member 30 slopes downwardly toward drip slits 50 from frozen confection receiving member 40 and outer edge 35. As such, drip slits or openings 50 may be positioned at the lowest points in the upper surface of drip catching member 30. In this embodiment, and as shown in FIG. 6, aperture 45 may still be lower than outer edge 35, or it may be located as high as or higher than outer edge 35.

Several optional features of the present invention are also shown in FIGS. 4-6. FIG. 4 illustrates ridges 26 on handle 20, which may be used to prevent the handle from slipping through a user's grasp. As will be understood, ridges 26 could have various shapes and positions, and other slip-preventative measures are also envisioned. Additionally, FIGS. 5 and 6 illustrate a plug member 70 at the bottom end 22 of handle 20. Handle 20 may include a through-hole at bottom end 22 through which caught drips 5 can be released when desired. In this embodiment, plug member 70 is preferably removably insertable into such through-hole to seal bottom end 22 of handle 20 to contain drips 5. When desired, a user may remove plug member 70 from the through-hole to release such drips 5, such as for cleaning the frozen confection holder 10. It is envisioned that plug member 70 may screw into place, snap into place, be held in place by friction, or be secured in any other manner so as to contain and sealably hold drips 5 within reservoir 60. Alternatively, bottom end 22 of handle 20 may include no through-holes, so as to be a generally uniform surface.

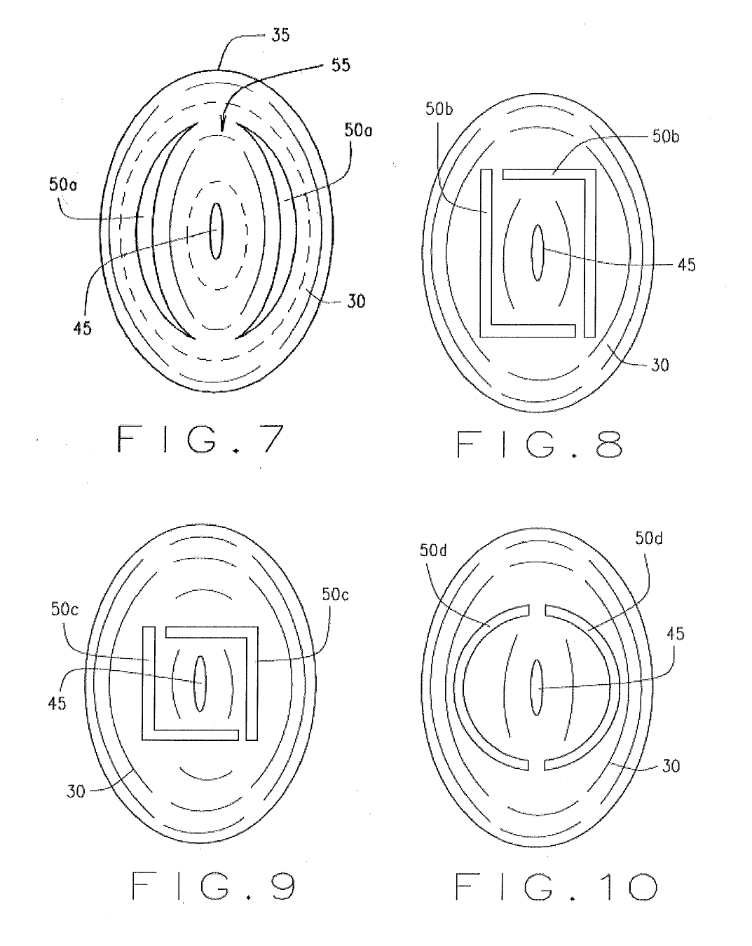

Drip catching member 30 may have any desired transverse cross-sectional shape. In FIGS. 4-11, the drip catching member 30 is shown as having a transverse cross-sectional shape of an ellipse. The cross-sectional view of FIG. 5 is taken across the semi-major axis of the elliptical cross section, while the cross-sectional view of FIG. 6 is taken across the semi-minor axis of the elliptical cross section. As such, in a preferred embodiment, the drip catching member 30 is longer than it is wide as illustrated in FIGS. 7-11, so as to mimic the shape of many frozen confections. Nevertheless, a frozen confection holder 10 designed for a differently shaped frozen confection may include a drip catching member 30 with a different transverse cross-sectional shape as needed or desired.

FIG. 7 illustrates a top down view of the drip catching member 30. Drip pass-through region 55 is shown which includes a least one drip slit or opening 50a. Drip pass-through region 55 is, like the drip slits or openings 50 discussed above, separate from and positioned outwardly from the frozen confection receiving member 40, and separate from and positioned inwardly from outer edge 35 of said drip catching member 30. Preferably, drip slits or openings 50 are located within the drip pass-through region 55. In FIG. 7, drip pass-through region 55 includes two symmetric crescent-shaped drip slits 50a which roughly mirror the elliptical cross-sectional shape of the drip catching member 30. However, various other drip slit 50 shapes are envisioned, such as the rectangular shaped drip slits 50b illustrated in FIG. 8, the square shaped drip slits 50c illustrated in FIG. 9, and the circular shaped drip slits 50d illustrated in FIG. 10. Further, only one drip hole or slit 50, or a plurality of drip holes or slits 51 which form one of the above discussed shapes may be used. For example, FIG. 11 illustrates a drip catching member 30 with a plurality of drip holes 51 positioned and located to form a roughly symmetrical crescent orientation.

It is noted that specific drip slit or opening 50 shapes may be used in connection with frozen confections 1 of similar shapes. For example, the roughly square-shaped drip slits 50 illustrated in FIG. 9 may more efficiently allow drips 5 to migrate down into the reservoir 60 when used in connection with a frozen confection having a square cross-sectional shape. Similarly efficient drip migration may be achieved with the circular drip slit 50 layout illustrated in FIG. 10 when circular frozen confections are used.

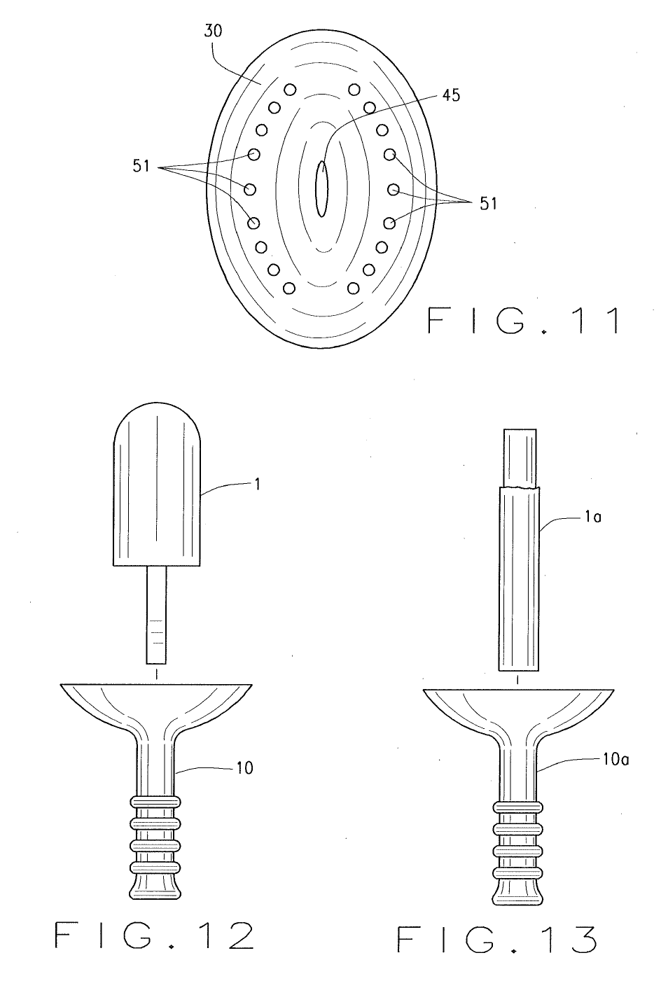

FIGS. 12 and 13 illustrate exploded views of frozen confections 1, 1a as used with the present frozen confection holders 10, 10a. It is noted that the present frozen confection holders may also be used in connection with stick-less frozen confections 1a. For example, in FIG. 13, frozen confection 1a is embodied as a “freeze pop” or “ice pole”, which is essentially a frozen confection housed in a plastic tube. For consumption, the top of the plastic tube is cutoff, exposing the frozen confection. In practice, the bottom of freeze pop 1a may be inserted through aperture 45 as shown in FIG. 13, allowing a user to consume the top, exposed portion of freeze pop 1a. Aperture 45 may be somewhat larger in size to accommodate a stick-less frozen confection, such as freeze pop 1a. As noted, use with other types of stick-less frozen confections 1a is likewise anticipated and envisioned.

Frozen confection holder 10 may be formed of any suitable material. Preferably, a material that is flexible and resilient, possibly with insulating and non-stick properties would be used. An example of a suitable material is silicone, and more preferably medical grade silicone. Other suitable materials are envisioned as would be known in the art.

Thus, there has been shown and described several embodiments of a frozen confection holder comprising a handle, a drip catching member, a frozen confection receiving member and at least one drip slit located within a drip pass-through region spaced inward from the outer edge of the drip catching member, and outward from the frozen confection receiving member. As various modifications could be made to the exemplary embodiments as described above with reference to the corresponding illustrations without departing from the spirit and scope of the present invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the above disclosures, their equivalents, and the claims which follow.

What is claimed is:

1. A holder for frozen confections comprising:
a handle extending longitudinally from a top end to a bottom end, and having an internal hollow, said hollow serving as a reservoir for retaining drips from a frozen confection;
a drip catching member extending radially outward from the top end of said handle to an outer edge of said drop catching member, said drip catching member roughly forming a bowl shape and positioned to receive drips from the frozen confection;
a frozen confection receiving member positioned generally toward the center of said drip catching member, said frozen confection receiving member including an aperture extending through said drip catching member and through the top end of said handle, said aperture being configured to receive a stick of a frozen confection through said drip catching member and through the handle top end into said handle reservoir; and
at least one drip opening separate from and positioned outwardly from said frozen confection receiving member, and separate from and positioned inwardly from the outer edge of said drip catching member, said at least one drip opening extending through said drip catching member and through the handle top end for communication with said handle reservoir for allowing frozen confection drips caught by said drip catching member to drip down into said handle reservoir for storage.

2. The frozen confection holder of claim 1 including:
a hole extending through the bottom end of said handle into said internal reservoir; and
a plug for removable insertion into said hole, said plug for holding drips within said internal reservoir when engaged with said hole, and for releasing said drips when removed from said hole.

3. The frozen confection holder of claim 1 wherein the shape of said at least one drip opening mirrors the transverse cross-sectional shape of an intended frozen confection.

4. The frozen confection holder of claim 3 wherein said at least one drip opening forms a generally rectangular shape around said frozen confection receiving member.

5. The frozen confection holder of claim 3 wherein said at least one drip opening forms a generally square shape around said frozen confection receiving member.

6. The frozen confection holder of claim 3 wherein said at least one drip opening forms a generally circular shape around said frozen confection receiving member.

7. The frozen confection holder of claim 1 wherein the drip catching member is elongated such that its transverse cross section is elliptical in shape.

8. The frozen confection holder of claim 7 wherein the at least one drip opening is elongated and runs parallel to the semi-major axis of the transverse elliptical cross section of the drip catching member.

9. The frozen confection holder of claim 8 including at least a second elongated drip opening which runs parallel to the semi-major axis of the elliptical transverse cross section of the drip catching member opposite the first drip opening.

10. The frozen confection holder of claim 1 wherein said at least one drip opening is positioned within a depression in said drip catching member such that said drip catching member slopes downwardly toward said at least one drip opening from said frozen confection receiving member and from said outer edge.

11. The frozen confection holder of claim 1 wherein said at least one drip opening is positioned approximately halfway between said aperture and said outer edge.

12. The frozen confection holder of claim 1 wherein said frozen confection holder is formed of a flexible, resilient material.

13. The frozen confection holder of claim 12 wherein said frozen confection holder is formed of silicone.

14. A frozen confection holding system comprising:
a frozen confection;
a handle for holding said frozen confection having a top end, a bottom end and an internal hollow, said hollow serving as a reservoir for retaining drips from the frozen confection;
a drip catching member having a funnel shape extending outwardly from the top end of said handle to an outer edge of said drip catching member;
a frozen confection receiving member positioned generally toward the center of said drip catching member, said frozen confection receiving member including an aperture extending through said drip catching member and through the top end of said handle, said aperture being configured for receiving a frozen confection; and
at least one drip pass-through region separate from and positioned outwardly from said frozen confection receiving member, and separate from and positioned inwardly from the outer edge of said drip catching member, said at least one drip pass-through region including at least one drip opening extending through said drip catching member and through the handle top end for communication with said handle reservoir for allowing frozen confection drips caught by said drip catching member to migrate down into said handle reservoir for storage.

15. The frozen confection holding system of claim 14 wherein the aperture of said frozen confection receiving member is configured for receiving the stick of a frozen confection.
